(19) United States
(12) Patent Application Publication
(10) Pub. No.: US 2009/0132937 A1
(43) Pub. Date: May 21, 2009

(54) Modifying Hover Help for a User Interface

(75) Inventors: Lloyd W. Allen, Jr., Cary, NC (US); Jana H. Jenkins, Raleigh, NC (US); Steven M. Miller, Cary, NC (US)

Correspondence Address: MARCIA L. DOUBET LAW FIRM, PO BOX 422859, KISSIMMEE, FL, 34742, US

(73) Assignee: INTERNATIONAL BUSINESS MACHINES CORPORATION, Armonk, NY (US)

(21) Appl. No.: 11/941,044

(22) Filed: Nov. 15, 2007

(51) Int. Cl. G06F 3/00

(52) U.S. Cl. 715/762

(57) ABSTRACT

Enabling end users to modify hover help provided for an application's user interface. An end user can tailor the application-provided hover help information to his own needs by editing thereof, or by providing a complete replacement therefor. A copy of the originally-provided hover help may be retained, and may be restored (e.g., upon user request).

### CROSS-REFERENCE TO RELATED APPLICATION

Commonly-assigned U.S. patent application Ser. No. 11/______, which is titled “Appending Hover Help to Hover Help for a User Interface” and which was filed concurrently herewith.

### BACKGROUND OF THE INVENTION

The present invention relates to computers, and deals more particularly with enabling end users to modify hover help that is provided in a user interface (“UI”) of a software application.

Hover help is sometimes referred to as an “info pop”, and refers to a technique whereby a small window pops up, responsive to an end user pausing a cursor (such as a mouse cursor or other pointing device cursor) temporarily over an icon or other element which is rendered on a user interface and for which hover help has previously been created. This pop-up window displays the previously-created help information pertaining to the icon or element.

### BRIEF SUMMARY OF THE INVENTION

The present invention is directed to modifying hover help for a user interface. In one embodiment, this comprises: for each of at least one selected rendered element of a user interface, responding to a request for modifying existing hover help for the selected rendered element by retrieving the existing hover help for the selected rendered element; displaying the retrieved hover help for modifying thereof; and storing the modified hover help; and responding to a request for displaying the hover help for any of at least one rendered element of the user interface by displaying the modified hover help for the rendered element if the rendered element has been modified and by displaying the existing hover help for the rendered element otherwise. The modifying may comprise revising the existing hover help or replacing the existing hover help. Optionally, a copy of the existing hover help is retained for each of the at least one selected rendered elements for which the existing hover help is modified. In this case, responsive to a request to restore the existing hover help for each of at least one particular one of the selected rendered elements of the user interface, the retained copy of the hover help for the particular one is used as the hover help therefor and the modified hover help for the particular one is removed.

The existing hover help may be identified in a data structure (such as a markup language document) and the storing of the modified hover help may comprise adding an indication of the modified hover help to the data structure. The request to modify the existing hover help may comprise activation of a key or key sequence from the user interface of the application; activation of a right-click function from the user interface of the application; selection of a choice from a menu displayed responsive to activation of a right-click function from the user interface of the application; and so forth.

Embodiments of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 provides an example of a complex user interface for an application, according to the prior art;

FIG. 2 illustrates user-provided replacement hover help that is rendered as the hover help for an element of FIG. 1, instead of the application-provided hover help shown in FIG. 1, according to an embodiment of the present invention;

FIG. 3 depicts a sample dialog window approach for editing application-provided hover help, according to an embodiment of the present invention;

FIG. 4 illustrates a sample data structure showing how user-provided hover help may be stored, according to an embodiment of the present invention;

FIG. 5 provides a flowchart depicting logic which may be used when implementing an embodiment of the present invention;

FIG. 6 depicts a data processing system suitable for storing and/or executing program code; and

FIG. 7 depicts a representative networking environment in which one or more embodiments of the present invention may be used.

### DETAILED DESCRIPTION OF THE INVENTION

Embodiments of the present invention are directed toward enabling end users to modify hover help provided for an application's user interface. Typically, the hover help to be edited is originally provided by the software developer for the application. Accordingly, the original hover help is referred to herein (by way of illustration but not of limitation) as “application-provided hover help”. Using techniques disclosed herein, an end user can tailor the application-provided hover help information to his own needs.

A user interface rendered by an application program may contain a substantial amount of information, and/or information that is complex or confusing, especially for novice users. Some end users may find that the hover help provided with the application, or perhaps some portion of the hover help, is not particularly helpful to them or does not align with their personal or enterprise-specific interpretation of the rendered data. Or, there may be scenarios where the user prefers using his own separately-stored reference information instead of the application-provided hover help. For example, an end user might create his own separate help documents, procedures, or “cheat sheets” containing reminders or explanations of enterprise-specific conventions, procedures, and practices pertaining to data rendered in an application interface. Such information might explain, for example, how to use particular fields in the user interface when performing enterprise-specific tasks or might remind the user of enterprise-specific settings to be used with tasks pertaining to a particular element of the user interface.

A drawback of this existing approach is that the user's separately-stored information is not integrated with the application-provided hover help. It may therefore be cumbersome for the user to locate his preferred, separately-stored information when it is needed, and he may in some cases forego using his preferred separately-stored information as a result, which in turn may lead to a less-productive or less-accurate interaction with the rendered UI.

The present invention is directed to enabling end users to modify application-provided hover help or, more generally, hover help that is provided in a UI of a software application. An embodiment of the present invention provides a mechanism that is included within the application interface to allow an end user to edit some portion of the application-provided hover help, or to provide a complete replacement for the application-provided hover help, and to store this edited or replacement version for subsequent use in the application interface. (The term “user-provided hover help” is used herein, for ease of reference, to refer to hover help as edited by the user, whether that “as-edited” hover help comprises a complete replacement of the application-provided hover help or merely a revised version thereof.)

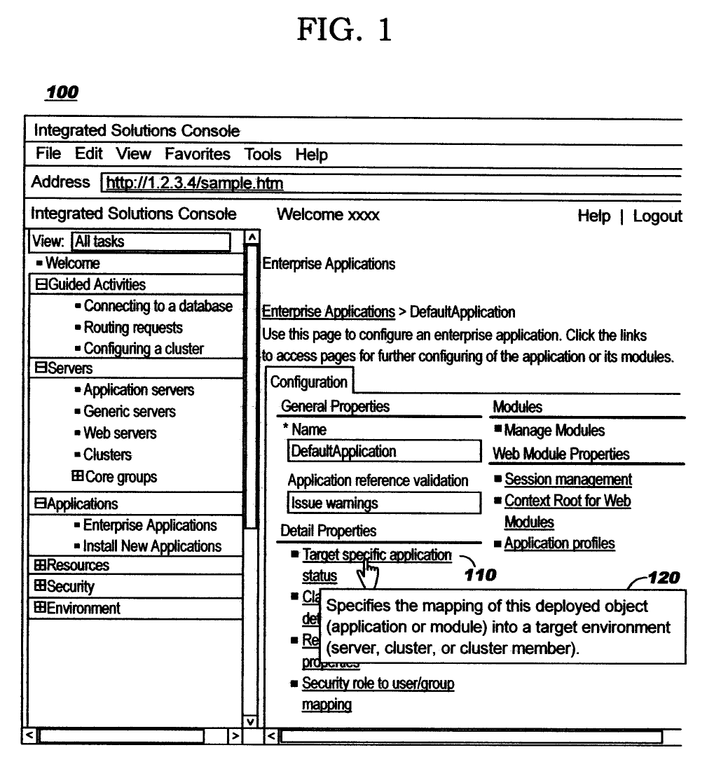

See FIG. 1, which provides an example of a complex UI 100 for an application. FIG. 1 provides an illustration of hover help according to the prior art, whereby the user has paused the mouse cursor over a hyperlink element having text “Target specific application status”. See reference number 110. This hyperlink text generally describes the function of the display “panel” or screen that the link will open if selected. The hover help window 120 displayed in response to hovering the mouse cursor over this hyperlink 110 contains text stating “Specifies the mapping of this deployed object (application or module) into a target environment (server, cluster, or cluster member).”.

Using an embodiment of the present invention, the user can enter different or additional text to be used as the hover help for a displayed element (including, if desired by the user, an explicit reference to where the user has previously stored separate help information pertaining to this displayed element).

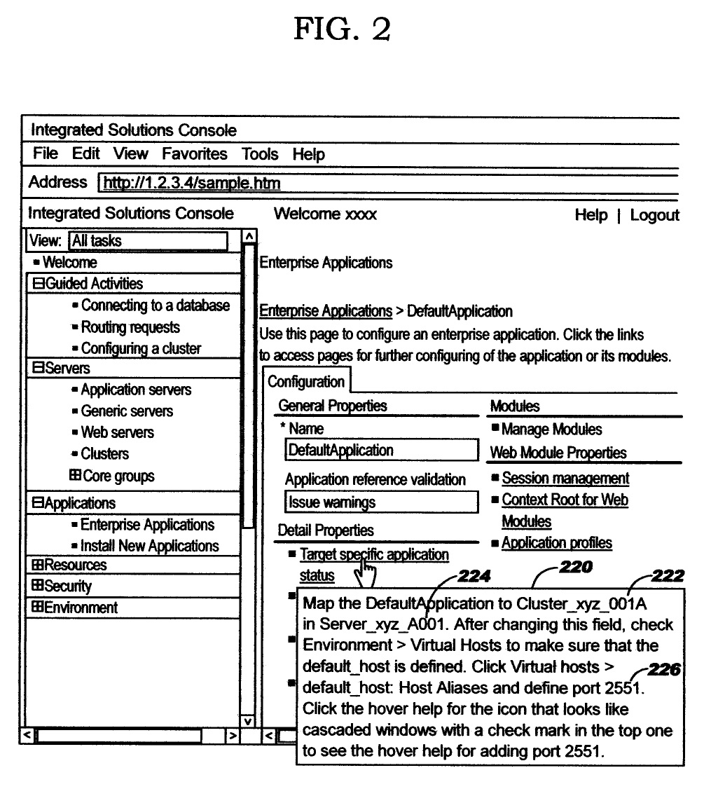

See FIG. 2, which illustrates user-provided replacement hover help 220 that is now rendered as the hover help for the hyperlink element 110, instead of the application-provided hover help 120 shown in FIG. 1. As can be seen by this sample replacement hover help 220, the hover help 220 is now very specific to the particular enterprise in which this user is working. Hover help 220, in this example, provides four sentences, each of which specifies guidance or reminders regarding particular steps that should be taken by the user as he interacts with the application interface. Hover help 220 also provides, in this example, a number of parameter values that may be specific to this enterprise and that should be used by the user during his interaction with the application interface. See, for example, reference numbers 222, 224, and 226.

As can be seen by comparing the hover help 120 of FIG. 1 to the replacement hover help 220 of FIG. 2, the replacement version will generally be more useful to the end user because it describes how to interact with the underlying user interface element in terms that are tailored to this user and his enterprise.

The user may activate entry of user-provided hover help (i.e., user editing or replacement of the already-existing hover help) in various ways without deviating from the scope of the present invention. In one approach, the user right-clicks over the rendered element (referred to alternatively herein as a rendered field) for which hover help editing is to be provided. If there are no right-click functions already defined for this field, then the application-provided hover help may be immediately displayed, for editing, in a dialog window. On the other hand, if there are existing right-click functions for this field, an entry such as “Edit hover help” may be displayed in the list or menu that pops up responsive to the right click activation, and clicking this displayed entry preferably opens a dialog window containing the application-provided hover help to be edited. In another approach, a “hot key” (such as a function key or other predetermined key sequence) may be defined that, when activated, presents a dialog window for editing of hover help. The manner in which hover help editing is activated may vary from one application to another, without deviating from the scope of the present invention, and may be configurable. As an example of configuring the activation of hover help editing, a particular application might consult a configuration file to determine that a key sequence such as “Alt+F1” indicates that the user wishes to invoke hover help editing, while a different application might learn from its configuration file that a right-click over a field for which application-provided hover help exists is a signal that the user wishes to invoke the hover help editing.

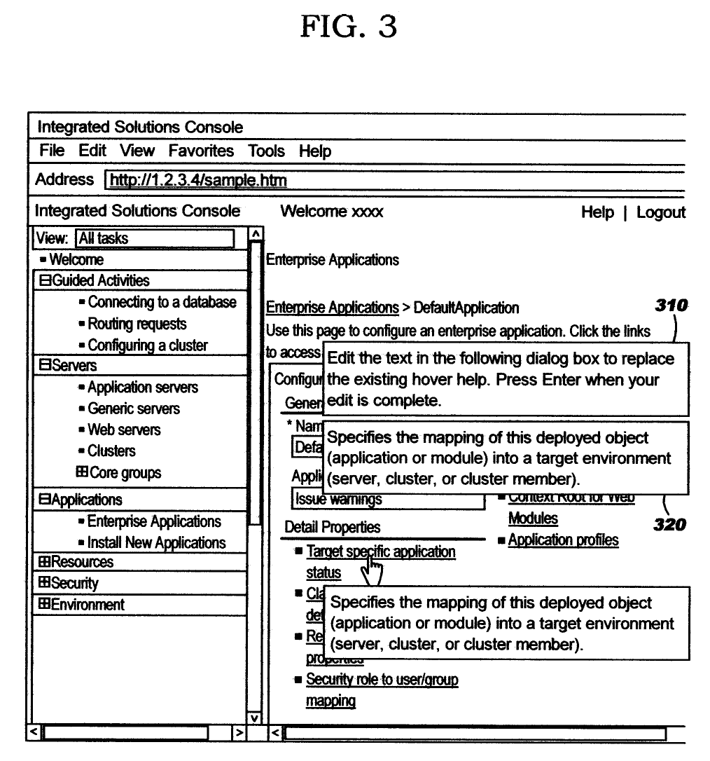

FIG. 3 depicts a sample dialog window approach for editing hover help. As shown therein, in one embodiment a first window 310 is displayed that provides instructions to the user on how to edit the application-provided hover help, and a second window 320 is displayed with a copy of that hover help. The user may then edit the hover help displayed in window 320, for example by annotating it with hints or other information, or he may replace it completely.

A schema may be provided to define allowable hover help edits. Optionally, a formatting command or commands may be supported. In one embodiment, a user is allowed to enter a “<p>” (i.e., paragraph) command in the edited hover help to indicate that a paragraph break should be provided when the text of the user-provided hover help is rendered. A “<b>” command may also be supported, if desired, thereby allowing the user to indicate that some portion of the user-provided hover help should be rendered in bold face. In addition or instead, an embodiment may support user entry of graphics, such as allowing a user to provide a file path or Uniform Resource Locator (“URL”) that identifies a location of an image file to be rendered within the user-provided hover help for a particular field.

In one approach, the syntax that is allowable for edits within the user-provided hover help depends on the capabilities of the rendering device, and any valid formatting or highlighting markup syntax or tags may be specified by the editing user. In this approach, any user-provided markup that is not supported by the rendering device is preferably ignored during rendering. Or, the allowable edits may use a schema that is inherited from the existing hover help capability. In this approach, if the original help supported features such as highlighting or graphics, then such features may be provided by a user who is editing the existing hover help.

The user-provided hover help text may be stored, in one approach, as one or more Extensible Markup Language (“XML”) documents that are external to the application. Accordingly, the allowable hover help syntax may adhere to a schema for XML documents. The user-provided hover help, whether it comprises an edited version of the original hover help or a complete replacement therefore, is stored in product-related data files according to one embodiment of the present invention. For example, a configuration file associated with a software product may identify a file path or other storage structure to be used for data files associated with applications within that software product. In another embodiment, the user-provided hover help is stored within a user data section of the application directory structure. In yet another embodiment, the user-provided hover help is stored at a location designated by the end user in a preferences file, configuration file, policy file, or other similar mechanism (which may identify, for example a path name or directory structure in which edit files created by this user are to be stored).

More generally, the user-provided edits may be stored at a location for which the user has read/write access. In one approach, the user-provided edits are stored in local storage on the user's workstation. In another approach, such edits are stored on a server that is accessible to an invocation of the application and for which this user has read/write access. An administrator may create user-provided edits that are then viewable for multiple end users of an enterprise, if desired. In this latter approach, the administrator-provided edits to hover help may be stored as user-provided hover help files on a server from which a plurality of end users then retrieves those files.

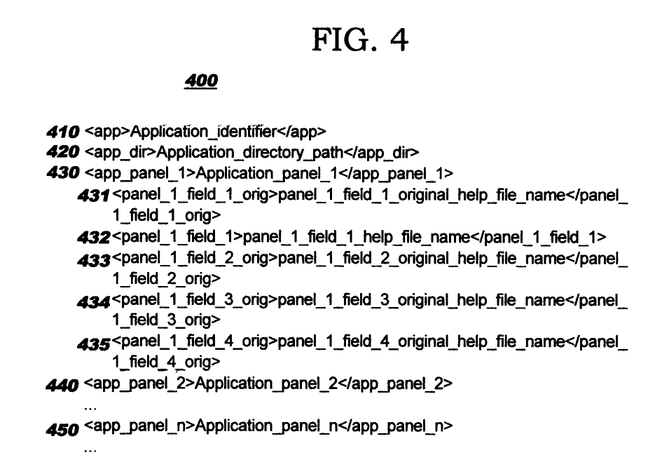

In one embodiment, the user edits to the original hover help are stored separately from the original application-provided hover help. This approach is illustrated in FIG. 4. As shown therein, the sample syntax in XML document 400 specifies hover help for each of the panels or screens that may be rendered by a particular application at run time. An <app> tag 410 is used, in this example, to identify the application to which this document 400 pertains, and an <app_dir> tag 420 specifies a file path indicating the directory structure where hover help files for this application are stored. An <app_panel_x> tag identifies, in this example, each of the panels that may be rendered by this particular application, where “x” takes on values from 1 through the number of application panels. See reference numbers 430, 440, 450. In this sample document 400, a <panel_x_field_y_orig> tag provides the name of a file containing original, application-provided hover help for a particular field “y” of a panel “x” in this application, whereas a <panel_x_field_y> tag (i.e., omitting the “orig” at the end) indicates that the application-provided hover help for that same field “y” of panel “x” has been overridden with user-provided hover help and specifies the name of a file containing this user-provided hover help. See, for example, reference numbers 431, 433, 434, 435, which provide names of files containing original, application-provided hover help, and reference number 432, providing the name of a file containing user-provided hover help. In this example, the user-provided hover help identified at 432 is to be used for “field_1” of “panel_1” at run time instead of (i.e., as an override for) the application-provided hover help identified at 431.

In one embodiment of the present invention, the original version of the hover help is retained and may be restored at any time, for example upon request of the end user. This restoring is facilitated, in one approach, by the separate storing of the user-provided hover help and the original application-provided hover help, as illustrated by XML document 400 of FIG. 4. For example, the original hover help for “field_1” of “panel_1” can be restored, if desired, using the file name provided at 431. In this embodiment, the original hover helps are not changed when the user provides modifications. Instead, a new file is created for storing any user-provided hover help, and this override may be identified using a tag syntax such as that illustrated by reference numbers 431, 432 of FIG. 4.

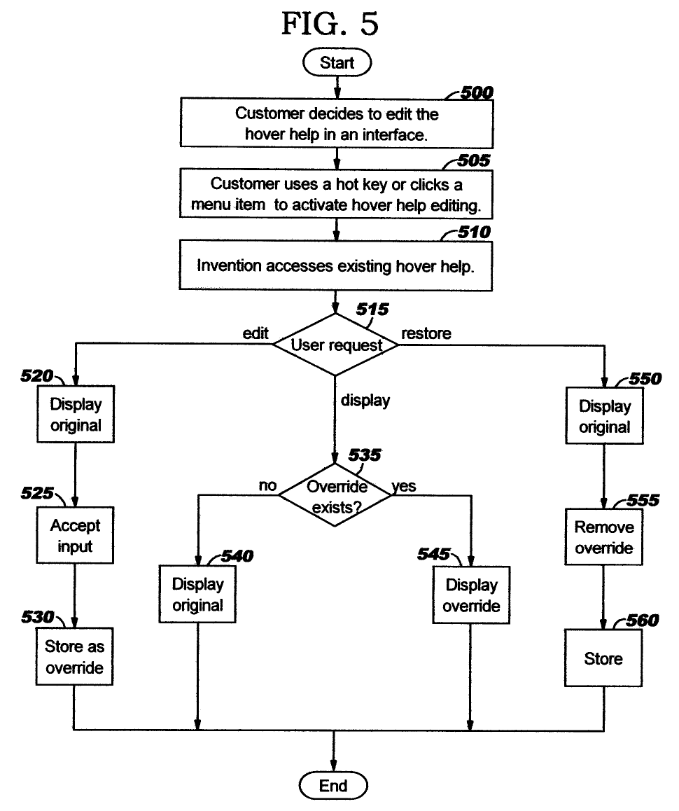

Turning now to FIG. 5, a flowchart is provided depicting logic that may be used when implementing an embodiment of the present invention. As shown therein, a user decides at some point to edit the hover help (or multiple hover helps) provided by an application on the user interface (Block 500). Accordingly, the user presses a hot key, function key, key sequence, or right-clicks a menu item to activate hover help editing (as discussed earlier) for a particular element rendered on the user interface of this application (Block 505). In response, an embodiment of the present invention accesses the existing hover help pertaining to this rendered element (Block 510). As one example of this accessing, an XML document corresponding to hover help for the currently-rendered application may be located, and tags within the XML document corresponding to the currently-rendered panel and its field(s) may be located.

Suppose, for example, that the user indicates that he wishes to edit the hover help for a field having identifier “field_1” on a panel having identifier “panel_1” within an application having identifier “Application_identifier”. In this example, tags 431, 432 within XML document 400 may be located.

An embodiment of the present invention then tests (Block 515) what type of interaction is requested by the user. If editing of hover help is requested, then processing continues at Block 520 where a copy of the existing hover help is preferably displayed for editing in a window such as dialog window 320 of FIG. 3. A window such as window 310 may also be displayed that provides instructions to the user on how to edit the application-provided hover help. User edits for this hover help are then accepted (Block 525) and as stated earlier, these edits may comprise revising the displayed hover help, or alternatively, providing a complete replacement for that hover help. When the user has finished providing edits, a “Save” or “Store” key (or other activation mechanism) may be selected by the user to indicate that the user-provided edits for this field are now complete. In response, the user-provided edits are stored as an override of the original application-provided hover help (Block 530). Processing may then exit from FIG. 5. As one alternative, the processing of FIG. 5 may iterate (for example, by returning control to Block 515) with regard to the field over which the cursor is positioned. As yet another alternative, a new cursor position may be sensed, and the processing of FIG. 5 may be repeated with regard to that field.

Referring to the examples discussed above, suppose that “field_1” corresponds to the hyperlink element 110 of FIG. 1 and that an XML document similar to document 400 of FIG. 4 (but not containing element 432) identifies where the hover help files for panel 100 of FIG. 1 are stored. The processing of Block 520 may comprise rendering window 320 of FIG. 3 (and optionally window 310 of FIG. 3 as well), using hover help retrieved from the file or other storage location identified in element 431 of FIG. 4. The processing of Block 525 may comprise accepting input such as the replacement text shown at 220 of FIG. 2, and the processing of Block 530 may comprise storing the replacement text in a particular location and updating the XML document to include the identifier of that location (for example, using an element such as element 432 of FIG. 4).

As one alternative to using a document such as document 400 of FIG. 4 to identify field-specific hover help, an application might use a table or other data structure that associates hover help file names with fields of a panel. In this case, the data structure may be updated or revised to specify a location of the user-provided hover help. A field-specific key might be provided, for example, that identifies a cell or row in such data structure. The value mapped to the key may then be changed to point to the user-provided hover help, instead of the application-provided hover help, responsive to the user editing of hover help.

If Block 515 determines that the user requested display of the hover help for a particular field of the rendered UI, then processing continues at Block 535, which tests whether an override to the hover help exists for this field. If not, the originally-provided hover help (if any) is rendered at Block 540; otherwise, at Block 545, the user-provided hover help is rendered. In either case, the processing of FIG. 5 may end or may iterate, as discussed above with regard to the “edit” branch of FIG. 5. The rendered hover help may be removed automatically from the panel according to existing techniques (e.g., upon expiration of a timer).

If Block 515 determines that the user requested restoring the original application-provided hover help for a particular field of the rendered UI, then processing continues at Block 550. As shown therein, this original hover help is rendered. At Block 555, any user-provided overrides for that hover help are preferably removed. With reference to document 400 of FIG. 4, for example, element 432 may be removed during the processing of Block 555. The revised hover help information (such as a revised version of document 400) is then preferably stored (Block 560). The processing of FIG. 5 may then end or may iterate, as discussed above with regard to the “edit” branch of FIG. 5.

While the functions comprising the processing of FIG. 5 have been described as occurring dynamically during run time, whereby (for example) editing may be integrated with run-time display of hover help, a user may alternatively choose to carry out editing of hover help as a separate function. That is, the processing of FIG. 5 may be invoked to perform hover help edits, and the application may be exited once those edits are provided, such that the user-provided hover help is accessible when the user returns to the application for actual run-time use thereof.

As one alternative to using different tags within an XML document to identify original application-provided hover help and user-provided hover help, an embodiment of the present invention may set a bit (or other indication) associated with individual fields of a panel to thereby indicate whether such fields have user-provided hover help. The processing of Block 535 may then comprise checking this bit setting (which may, for example, be associated with a table or mapping that uses a field-specific key, as discussed above).

If a particular application does not allow overwriting its existing hover help, then the processing of Block 535 preferably comprises intercepting a call to display hover help and determining whether to display the application-provided hover help or the user-provided hover help. If an application does not use a data structure such as document 400 of FIG. 4 to record locations of its hover help files, an embodiment of the present invention may create such data structure for use with the present invention (e.g., by processing an existing mapping between user interface field identifiers and identifiers of hover help files associated with those field identifiers).

In one embodiment, an application uses an event-driven mechanism for requesting the rendering of hover help, whereby an event is published that signifies “display the hover help associated with field y on panel x”. An event listener, according to this embodiment, receives the event and retrieves the hover help for that field either from the application-provided hover help or from the user-provided hover help. Which version to render may be determined using a bit setting, as has been described, or as one alternative, by consulting syntax as illustrated in XML document 400 (see reference numbers 431, 432) that explicitly indicates the presence of a user's override of the application-provided hover help.

As one alternative to using an XML document for identifying hover help files, a properties file might specify hover help (e.g., as plain text). As another alternative, a document encoded in the Hypertext Markup Language (“HTML”) or other markup language might specify hover help.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

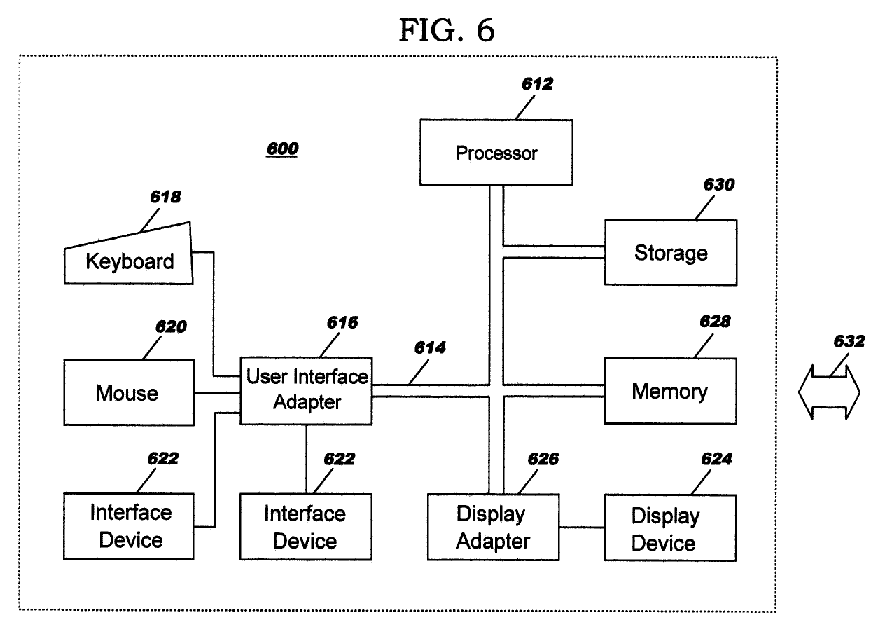

Referring now to FIG. 6, a data processing system 600 suitable for storing and/or executing program code includes at least one processor 612 coupled directly or indirectly to memory elements through a system bus 614. The memory elements can include local memory 628 employed during actual execution of the program code, bulk storage 630, and cache memories (not shown) which provide temporary storage of at least some program code in order to reduce the number of times code must be retrieved from bulk storage during execution.

Input/output (“I/O”) devices (including but not limited to keyboards 618, displays 624, pointing devices 620, other interface devices 622, etc.) can be coupled to the system either directly or through intervening I/O controllers or adapters (616, 626).

Network adapters may also be coupled to the system to enable the data processing system to become coupled to other data processing systems or remote printers or storage devices through intervening private or public networks (as shown generally at 632). Modems, cable modem attachments, wireless adapters, and Ethernet cards are just a few of the currently-available types of network adapters.

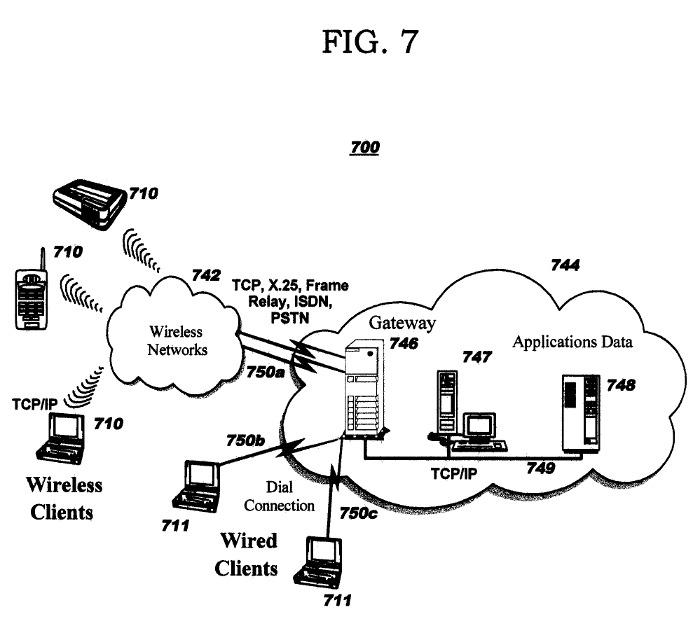

FIG. 7 illustrates a data processing network environment 700 in which the present invention may be practiced. The data processing network 700 may include a plurality of individual networks, such as wireless network 742 and network 744. A plurality of wireless devices 710 may communicate over wireless network 742, and a plurality of wired devices, shown in the figure (by way of illustration) as workstations 711, may communicate over network 744. Additionally, as those skilled in the art will appreciate, one or more local area networks (“LANs”) may be included (not shown), where a LAN may comprise a plurality of devices coupled to a host processor.

Still referring to FIG. 7, the networks 742 and 744 may also include mainframe computers or servers, such as a gateway computer 746 or application server 747 (which may access a data repository 748). A gateway computer 746 serves as a point of entry into each network, such as network 744. The gateway 746 may be preferably coupled to another network 742 by means of a communications link 750a. The gateway 746 may also be directly coupled to one or more workstations 711 using a communications link 750b, 750c, and/or may be indirectly coupled to such devices. The gateway computer 746 may be implemented utilizing an Enterprise Systems Architecture/390® computer available from IBM. Depending on the application, a midrange computer, such as an Application System/400® (also known as an AS/400®) may be employed. (“Enterprise Systems Architecture/390”, “Application System/400”, and “AS/400” are registered trademarks of IBM in the United States, other countries, or both.)

The gateway computer 746 may also be coupled 749 to a storage device (such as data repository 748).

Those skilled in the art will appreciate that the gateway computer 746 may be located a great geographic distance from the network 742, and similarly, the wireless devices 710 and/or workstations 711 may be located some distance from the networks 742 and 744, respectively. For example, the network 742 may be located in California, while the gateway 746 may be located in Texas, and one or more of the workstations 711 may be located in Florida. The wireless devices 710 may connect to the wireless network 742 using a networking protocol such as the Transmission Control Protocol/Internet Protocol (“TCP/IP”) over a number of alternative connection media, such as cellular phone, radio frequency networks, satellite networks, etc. The wireless network 742 preferably connects to the gateway 746 using a network connection 750a such as TCP or User Datagram Protocol (“UDP”) over IP, X.25, Frame Relay, Integrated Services Digital Network (“ISDN”), Public Switched Telephone Network (“PSTN”), etc. The workstations 711 may connect directly to the gateway 746 using dial connections 750b or 750c. Further, the wireless network 742 and network 744 may connect to one or more other networks (not shown), in an analogous manner to that depicted in FIG. 7.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention. Furthermore, while the discussion herein may refer to “an embodiment” or “one embodiment” of the present invention, such references are not necessarily discussing the same embodiment.

1. A computer-implemented method of modifying hover help for a user interface, comprising:
for each of at least one selected rendered element of a user interface, responding to a request for modifying existing hover help for the selected rendered element by retrieving the existing hover help for the selected rendered element; displaying the retrieved hover help for modifying thereof; and storing the modified hover help; and
responding to a request for displaying the hover help for any of at least one rendered element of the user interface by displaying the modified hover help for the rendered element if the rendered element has been modified and by displaying the existing hover help for the rendered element otherwise.

2. The method according to claim 1, wherein the modifying comprises revising the existing hover help or replacing the existing hover help.

3. The method according to claim 1, wherein a copy of the existing hover help is retained for each of the at least one selected rendered elements for which the existing hover help is modified.

4. The method according to claim 3, further comprising responding to a request to restore the existing hover help for each of at least one particular one of the selected rendered elements of the user interface by using the retained copy of the hover help for the particular one as the hover help therefor and removing the modified hover help for the particular one.

5. The method according to claim 1, wherein the modified hover help is stored on a server accessible to an invocation of the application.

6. The method according to claim 1, wherein the modifying is performed by a user of the application.

7. The method according to claim 1, wherein the modified hover help is stored on local storage of a workstation of a user of the application.

8. The method according to claim 1, wherein the existing hover help is identified in a data structure and where the storing of the modified hover help comprises adding an indication of the modified hover help to the data structure.

9. The method according to claim 8, wherein the data structure comprises a markup language document.

10. The method according to claim 1, wherein the existing hover help is identified in a markup language document and wherein the storing of the modified hover help comprises adding an element to the markup language document for identifying the modified hover help for each of the at least one selected rendered element of the user interface, the added element being distinct from an element in the markup language document that identifies the existing hover help for each of the at least one rendered element of the user interface.

11. The method according to claim 1, wherein the request to modify comprises activation of a key or key sequence from the user interface of the application.

12. The method according to claim 1, wherein the request to modify comprises activation of a right-click function from the user interface of the application.

13. The method according to claim 1, wherein the request to modify comprises selection of a choice from a menu displayed responsive to activation of a right-click function from the user interface of the application.

14. A hover help modifying system for modifying hover help for a user interface, comprising:
a computer comprising a processor; and
instructions which execute using the processor to implement functions comprising:
for each of at least one selected rendered element of a user interface, responding to a request for modifying existing hover help for the selected rendered element by retrieving the existing hover help for the selected rendered element; displaying the retrieved hover help for modifying thereof; and storing the modified hover help; and
responding to a request for displaying the hover help for any of at least one rendered element of the user interface by displaying the modified hover help for the rendered element if the rendered element has been modified and by displaying the existing hover help for the rendered element otherwise.

15. The system according to claim 14, wherein the modifying comprises revising the existing hover help or replacing the existing hover help.

16. The system according to claim 14, wherein:
a copy of the existing hover help is retained for each of the at least one selected rendered elements for which the existing hover help is modified; and
the functions further comprise responding to a request to restore the existing hover help for each of at least one particular one of the selected rendered elements of the user interface by using the retained copy of the hover help for the particular one as the hover help therefor and removing the modified hover help for the particular one.

17. A computer program product for modifying hover help for a user interface, the computer program product embodied on one or more computer-usable media and comprising computer-usable program code for:
for each of at least one selected rendered element of a user interface, responding to a request for modifying existing hover help for the selected rendered element by retrieving the existing hover help for the selected rendered element; displaying the retrieved hover help for modifying thereof; and storing the modified hover help; and
responding to a request for displaying the hover help for any of at least one rendered element of the user interface by displaying the modified hover help for the rendered element if the rendered element has been modified and by displaying the existing hover help for the rendered element otherwise.

18. The computer program product according to claim 17, wherein the existing hover help is identified in a data structure and where the storing of the modified hover help comprises adding an indication of the modified hover help to the data structure.

19. The computer program product according to claim 17, wherein the existing hover help is identified in a markup language document and wherein the storing of the modified hover help comprises adding an element to the markup language document for identifying the modified hover help for each of the at least one selected rendered element of the user interface, the added element being distinct from an element in the markup language document that identifies the existing hover help for each of the at least one rendered element of the user interface.

20. The computer program product according to claim 17, wherein the modifying comprises revising the existing hover help or replacing the existing hover help.
